(19) United States
(12) Patent Application Publication
(10) Pub. No.: US 2016/0090963 A1
(43) Pub. Date: Mar. 31, 2016

(54) ROTOR BLADE TIP

(71) Applicant: WOBBEN PROPERTIES GMBH, Aurich (DE)

(72) Inventors: Alexander Hoffmann, Emden (DE); Dennis Dulle, Haren (DE); Christian Clemens, Berlin (DE)

(21) Appl. No.: 14/443,343

(22) PCT Filed: Nov. 6, 2013
(86) PCT No.: PCT/EP2013/073188

§ 371 Date: May 15, 2015

(30) Foreign Application Priority Data
Nov. 15, 2012 (DE) 10 2012 220 936.0
Apr. 4, 2013 (DE) 10 2013 205 965.5

(51) Int. Cl. F03D 1/06

(52) U.S. Cl. CPC F03D 1/0675

(57) ABSTRACT

A rotor blade of a wind energy plant having a main component of the blade and a blade tip, whereby the blade tip is releasably attached to the main component by means of a connection device and the connection device has a tip section attached to the blade tip and a base section attached to the main component of the blade to receive the tip section, whereby the tip section has at least one fastener that extends to the base section for attaching the tip section to the base section, and the fastener for performing the attachment can be actuated through an opening in the surface of the blade tip.

### BACKGROUND

1. Technical Field

The present invention relates to a rotor blade of a wind energy plant having a main component and a blade tip. Furthermore, the present invention relates to a connection device for connecting such a main component of the blade to the rotor blade tip, and the present invention relates to a rotor blade tip, which hereinafter will be referred to as simply the blade tip, and the present invention relates to a method for mounting a blade tip on a main component of a rotor blade.

2. Description of the Related Art

An edge arc of a rotor blade for a wind energy plant is known from PCT/EP2003/014621. This rotor blade has a so-called rotor blade tip, which is mounted at the end of the rotor blade such that it is deflected.

A disadvantage of the edge arc disclosed in PCT/EP2003/014621 is that, as proposed, the edge arc, which can also be referred to as a rotor blade tip, is made out of aluminum. Accordingly, this edge arc can be heavy and expensive to manufacture.

The terms edge arc, rotor blade tip or simply blade tip are used synonymously in this application.

Wind energy plants, in particular those of the horizontal axis wind turbine type having conventionally three rotor blades, are well known, and an installation of this kind is shown in FIG. 5. In order to improve the aerodynamics, rotor blade tips are proposed, which are bent out of the rotor plane at the outer end of a rotor blade.

As today's modern wind energy plants use very large rotor blades, these may present a problem for transport. In this context, this may be facilitated by only mounting the bent or deflected blade tip on site. In addition it should be noted that, in the event of a lightning strike, lightning will strike the outer end of the rotor blade, thus the blade tip. Here too, a replaceable blade tip may be useful so that these may be replaced after a lightning strike.

A removable rotor blade tip is known from the international patent application WO2012/031976. There, it is proposed that a rotor blade tip be used in an end region of the rotor blade, and in addition, a positive locking connection be produced using a pre-stressed bar. In addition, a bolt may serve as a retaining element.

Such a connection may also be disadvantageous because, in any event, it is necessary to work through the surface of the rotor blade in order to actuate said retaining bolt. This thereby creates a defect at that location in the rotor blade. Painting to cover this would lead to this bolt being difficult to find again if it should become necessary to replace the blade tip. Also or otherwise, a defect of this kind can lead to the penetration of moisture into the material of the rotor blade. Both the rotor blade and the affected elements of the connection device can be permanently damaged thereby.

### BRIEF SUMMARY

One or more embodiments of the present invention may address at least one of the aforementioned problems. One embodiment is directed to a solution for connecting a rotor blade tip to the main component of a rotor blade is to be proposed, which simplifies removal and avoids damage to the rotor blade as much as possible. In particular, an especially lasting solution with low costs is proposed. In particular, an improved edge arc or an improved rotor blade tip respectively is to be proposed, which in particular can be produced more cost effectively. At least one alternative solution should be proposed.

According to one embodiment of the invention, an edge arc pursuant to embodiment 1 is proposed. Sub-claims and the embodiments 2 to 14 describe advantageous embodiments.

In order to eliminate the aforementioned disadvantages, an embodiment of the invention provides that the edge of the rotor blade tip be made out of the same material as the rotor blade, and that only the tip, namely the first part, be made out of an electrically conductive material.

One embodiment of the invention is based on the fact that

an edge arc made entirely out of aluminum is heavier than an edge arc made at least in part out of a glass fiber composite material.

The invention has the advantage, at least according to one embodiment, that the edge arc is made out of the same material as the rotor blade, at least in the connecting area between the rotor blade and the edge arc, and thus can be directly connected thereto by means of an adhesive bond.

Further details and advantages of the invention are also disclosed in the exemplary embodiments according to the drawings.

According to one embodiment of the invention, a rotor blade of a wind energy plant, the rotor blade having a main component and a blade tip, whereby the blade tip is releasably attached to the main component by means of a connection device. The connection device has a tip section and a base section. The tip section is attached to the blade tip, and the base section is attached to the main component and prepared to receive the tip section, thus adapted thereto. The tip section has at least one fastener that extends to the base section for fastening the tip section to the base section. The fastener is actuated through an opening in the surface of the blade tip in order to carry out the attachment. This opening should preferably be kept as small as possible, in particular small enough that the fastener can be actuated, but not inserted through the opening. In this way, the outwardly oriented hole can be kept as small as possible.

The rotor blade tip can thus be applied to the main component and locked into position through an opening in the surface of the blade tip.

This allows an opening in the main component of the rotor blade to be avoided. This has the particular advantage that it is relatively easy to produce the rotor blade tip as an individual component that is small as compared to the main component of the rotor blade. Any openings for actuating the fastener can be made precisely by means of manufacturing technology, whereby any damage to the blade tip can be avoided.

This also prevents the blade tip from being damaged by weather conditions. Should the blade tip nevertheless become damaged in this region, this represents only a minor problem because the blade tip can be replaced relatively inexpensively.

Actuation through an opening in the surface of the blade tip is done in such a way that an appropriate wrench or screwdriver is inserted through the opening to the fastener.

Preferably, the main section of the blade and, additionally or alternatively, the blade tip is predominantly made up of fiber reinforced plastic, in particular of glass fiber reinforced plastic. The main component of the rotor blade in particular has a number of support structures, which can be made out of a different material. In particular, the predominant part of the outer casing of the rotor blade, however, is preferably made up of fiber reinforced plastic such as glass fiber reinforced plastic. Other materials such as lacquer coatings or foil coatings may also be included. The use of carbon fiber reinforced plastic may also be considered.

It is proposed that for such a fiber reinforced plastic, the base section or the tip section respectively be laminated. The base section or the tip section respectively thereby has a corresponding region, in particular a region prepared as a profile, which can already be provided in the appropriate form during the manufacture of the rotor blade. The main component of the rotor blade or the blade tip respectively may thus already be present in position through the provision of the appropriate multi-ply weave and then the introduction of the corresponding resin in order to generate the fiber reinforced plastic, and therefore can be manufactured at exactly the same time. In this sense, lamination is to be understood in such a way that the corresponding approach to incorporating the base section or the tip section respectively is to apply this immediately to the multi-ply weave, or the multi-ply weave is disposed immediately on this section and impregnated with resins.

The tip section and/or the base section preferably have at least one connecting pin for tilt-resistant insertion into corresponding openings at the base section or the tip section respectively. Thus for example, two parallel pins may be provided at the tip section, which for fastening purposes are introduced, and in particular inserted into, corresponding holes in the base section. Likewise, these pins may be provided in the base section so that the tip section of the blade tip is placed on these pins. These pins are preferably introduced on the tip section however, as described above, in order to avoid any problems transporting the main component of the rotor blade.

A preferred rotor blade is characterized in that at least one fastener

engages in a corresponding holding fixture in the base section with a first end and

is disposed in the blade tip with a second end that faces away from the first end, in order to perform the attachment and disengage the attachment, whereby the second end is set into the blade tip below the opening of the surface of the blade tip in such a way that it can be actuated through the opening in this surface, and such that space remains between the second end and the surface in order to arrange a sealing means so that the opening can be closed flush with the surface.

The fastener thus extends from the blade tip section to the base section and therefore from the blade tip to the main component of the rotor blade. Accordingly, a first end of the fastener, which can also be referred to as the first section, can be anchored in the base section. The second end, which can also be referred to as the second section, is disposed in the tip section and therefore in the blade tip below the opening of the blade tip. Here, the arrangement below the opening refers to the corresponding surface in which the opening is disposed, and below the surface thus means inside the blade tip. This second end is thereby not immediately below the surface, however, but instead far enough inside the blade tip that sufficient space remains for a sealing means in or below the opening. Here, sufficient space is provided so that the sealing means can be inserted into the opening in such a way that it can create a flush seal, namely a seal that is flush with the surface. A mounted sealing means such as a mounted plug is thus avoided, making an aerodynamically advantageous configuration possible. It should be noted that the highest relative air speeds occur at the rotor blade tip.

The fastener is preferably designed as a bolt and can be screwed through the opening by the bolt head thereof, which thus forms the second end of the fastener, into the base section with the threads thereof, which form the first end of this fastener, being screwed into the base section.

One embodiment makes use of a bend in the blade tip and utilizes the correspondingly deflected region to provide the opening for actuating the fastener, namely the convex region of the bend or the outer region of the bend respectively in the sense of an outside curve. When the blade tip is thus deflected towards the pressure side of the rotor blade, the outward deflection is at or oriented towards the suction side of the rotor blade. It is proposed that the opening be provided in precisely this region.

According to one embodiment, it is proposed that a sealing means be used that, after the attachment of the blade tip to the main component of the rotor blade, forms an element of the rotor blade thus assembled. The sealing means is provided to be releasably attached in the opening and has an attachment mechanism therefore. In this regard, there is not merely a single-pieced, elastic material such as a plug present, but rather an attachment mechanism, which in particular is designed as an attachment mechanism that only establishes a fixed fastening in the corresponding opening when it is actuated.

The sealing means is preferably prepared in such a way that the form, circumference and/or width thereof may be modified, and in particular enlarged, by means of a compression in a longitudinal direction in order to be retained in the opening. This compression and the resulting modification to the form, the circumference or the width is preferably provided in only a section of the sealing means. In particular, an elastic component, in particular an elastic element, is compressed, and thereby increased in circumference, thereby being firmly fastened in the opening.

Compression is preferably carried out by rotating a compression means, in particular a bolt, whereby fastening in the opening is achieved. A rotation in the opposite direction leads to a corresponding expansion in the longitudinal direction and a decrease in the width, and thereby a release of the fastening.

In order to avoid the entire sealing means from rotating when the compression means is rotated, an embodiment provides that the sealing means has a retaining section that is adapted to the fastener or vice versa. This retaining section thus prevents the entire sealing means from rotating when this is correspondingly actuated, whereby the compression means and the sealing means as a whole are not attached to the fastener, however, but instead, the fastener only prevents the aforesaid rotation of the sealing means. This applies both to the attachment of the sealing means, and to the release of the sealing means.

A further embodiment proposes that the rotor blade be characterized in that the connection device is connected to a means of conducting lightning and is prepared to transmit electric current from lightning that strikes the blade tip to the main section of the blade, and in that the sealing means are preferably designed in such a way that they are electrically insulating, or designed in such a way that they are electrically conductive such that they can transmit the electric current from lightning that strikes the sealing means to the connection device. Lightning conducting means are thereby provided, which make it possible to conduct lightning that strikes the blade tip from the blade tip to the main component of the rotor blade by means of the connection device. To this end, the tip section can, for example, be connected to a corresponding lightning conductor in the blade tip such that electricity can be conducted, and in an engaged state or by means of the connecting pins, a capacity to conduct electricity to the base section may be established, whereby the base section in turn is connected to a means of conducting lightning in the main component of the blade. These pins and corresponding holding fixtures thereby have dimensions such that a corresponding current from lightning can be conducted at least temporarily.

To this end, the sealing means can be designed such that it is insulating, so that it can be expected that lightning will strike another part, specifically lightning conducting means provided in the blade tip. Alternatively, the sealing means may be specifically designed so that it is electrically conductive and, accordingly, may extend to the surface of the blade tip. Accordingly, the sealing element must be designed in such a way and electrically connected to the tip section such that an electric current from a lightning strike can be discharged via the sealing element, the tip section and the base section.

In addition, a connection device is proposed for connecting a main component of the blade and a blade tip of a rotor blade or of an edge arc of a rotor blade respectively with one another. This connection device has the elements, features and/or characteristics already described above in conjunction with at least one of the described embodiments of the rotor blade. Likewise, a blade tip of a rotor blade is proposed, which has the elements, features and/or characteristics already described above in conjunction with at least one of the embodiments of the rotor blade.

Preferably an edge arc or a blade tip respectively is proposed, which is characterized in that the first section is designed as an edge of the edge arc or of the blade tip respectively, and which entirely or partially encompasses the second section. The electrically conductive material thus encloses the electrically non-conductive material. Here, enclosure is carried out within the meaning of a completely or partially encircling edge or frame. In particular, the tip section of the blade tip and the two edges or edging of the blade tip or of the edge arc respectively are electrically conductive, in particular made out of metal. Of these two edges or edging respectively, one conventionally points essentially in the direction of movement of the rotor blade, when the wind energy plant is operating as intended, and the other edge or edging respectively points essentially in the opposite direction.

It has been recognized that lightning need not strike the tip of the blade tip, or need not strike only the tip of the blade tip, but can also be expected to strike the edges or edging, or there may be a local expansion that is not limited to the tip. With an appropriate design of the blade tip, the synergistic effect can preferably be used whereby the provision of the electrically conductive material, in particular metal, at the edges also achieves an electrical conduction of the current away from the tip to a connector for connecting to the main component of the rotor blade. Furthermore, there is also a synergistic effect whereby the mechanical resistance of the metal in addition to its capacity to conduct lightning can be exploited, in particular by providing metal at least at the edge or edging in the forward direction of the intended rotating movement of the rotor. In modern wind energy plants, which have a rotor diameter of up to 126 meters, a rotor blade tip can move at substantial speeds. At such high speeds, any contact with contamination or insects can easily cause damage.

The use of such an edge made of an electrically conductive material, in particular metal, can thus provide protection against such damage, increase lightning protection characteristics and, at the same time, create a rotor blade tip or an edge arc respectively having a comparatively low weight.

The first section, namely the electrically conductive, in particular metal section, is preferably designed as a frame to receive or enclose the second section. This frame can thus receive the second section and thereby achieve a good connection of both sections and, accordingly, create a stable blade tip or a stable edge arc respectively.

A further configuration proposes that the first section, namely in particular the frame, have a holding frame to receive the second section as well as an attachment frame for attachment to the holding frame, and thereby for attaching the second section to the holding frame. Thus the second section can be inserted or laid in the holding frame, whereby both elements are preferably already manufactured to be custom-fit. Finally, the attachment frame can be applied, inserted or engaged, namely in such a way that, for example, a part of the second section, e.g., a circumferential mounting or holding edge of the second section, is at least partially located between the holding frame and the attachment frame. The second section can hereby be enclosed or clamped in this region. The attachment of the attachment frames to the holding frame is done by element of fastenings, for example, bolts or rivets.

An edge arc according to at least one of the above described or later described embodiments is preferably prepared for attachment to the main component of the rotor blade. In particular, the attachment is done as described in conjunction with at least one embodiment of the rotor blade, of a connection device or of a method for forming a connection. It is hereby possible to produce a rotor blade in an advantageous manner, and in particular one that is only assembled in the region of the blade tip at the installation location. This facilitates the transport of the rotor blade and makes it possible to replace an edge arc or a blade tip respectively if necessary in the event of a lightning strike.

In addition, a method for mounting a blade tip on a main component of the blade of a rotor blade is proposed. The method uses a blade tip as described above in conjunction with at least one embodiment of the rotor blade. In addition, the blade tip must be mounted on a main component of a corresponding rotor blade.

The method proposes that the tip section of the blade tip first be placed on the base section, which is attached to the main component of the blade. The blade tip is thereby first placed on the main component of the rotor blade and locked into position in a next step through an actuation of the fastener, which was described above in conjunction with at least one embodiment of the rotor blade.

### BRIEF DESCRIPTION OF THE SEVERAL VIEWS OF THE DRAWINGS

The invention is now described in more detail below using embodiments as examples with reference to the accompanying figures.

FIG. 1 shows a perspective view of an edge arc according to one embodiment.

FIG. 2 shows a plan view of an edge arc similar to the schematic view in FIG. 2.

FIG. 3 shows a side plan view of the rotor blade connection, namely the connection to the main component of the rotor blade, for an edge arc similar to FIGS. 2 and 3.

FIG. 4 shows a schematic of a rotor blade of a wind energy plant having an edge arc.

FIG. 5 shows a perspective view of a wind energy plant.

FIG. 6 shows a connection device according to an embodiment of the invention in an exploded view, including a lightning receptor without sealing element.

FIG. 7 shows an exploded view of part of the connection device according to FIG. 6 having a rotor blade tip and having a suggested sealing element.

FIG. 8 shows a perspective view of a tip section of a connection device including a connected lightning receptor.

FIG. 9 shows a perspective, partially sectional view of a sealing element and part of a fixing device.

FIGS. 10 to 13 show different views of a blade tip or an edge arc respectively according to one embodiment.

### DETAILED DESCRIPTION

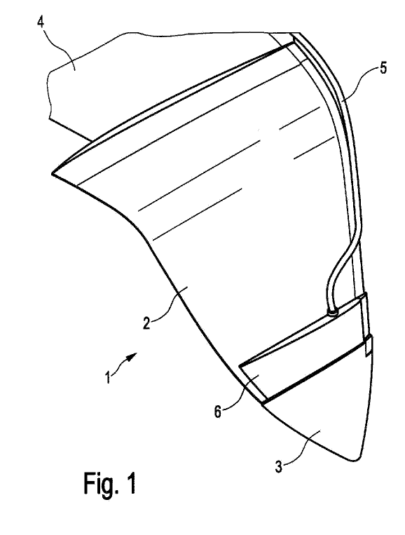

FIG. 1 shows a perspective view of an edge arc according to one embodiment of the invention. In this view, the inner part of the lightning receptor 6 and the lightning protection conductor 5 are shown as not covered. The lightning protection conductor 5 is located inside the edge arc 1. The tip of the lightning receptor 3 is made out of an electrically conductive material. Here, aluminum or stainless steel are especially suitable because these materials have a lower weight than steel or iron. The lightning protection receptor 3 is connected to an electrical conductor 5, which can also be referred to as a lightning protection conductor and which is guided to the connection point of the rotor blade 4. The electrical conductor 5 can either be a formed piece of steel or a cable.

This is connected to a lightning protection conductor of the rotor blade at the rotor blade connection 4. In the proposed embodiment, the connection is created by means of a screw connection.

Since the edge arc 1, with the exception of the lightning receptor, is made entirely out of glass fiber materials, the lightning receptor and the lightning protection conductor 5 are introduced into the glass fiber fabric during production and bonded. The edge arc is produced out of two half shells, one for the suction side, and one for the pressure side. The half shells are produced out of glass fiber mats by the use of a vacuum infusion method. At the end of production, the two half shells are bonded with the lightning receptor.

After production, only the tip of the lightning receptor 3 is visible on the outside. The inside part of the lightning receptor 6 is concealed by the edge arc 1.

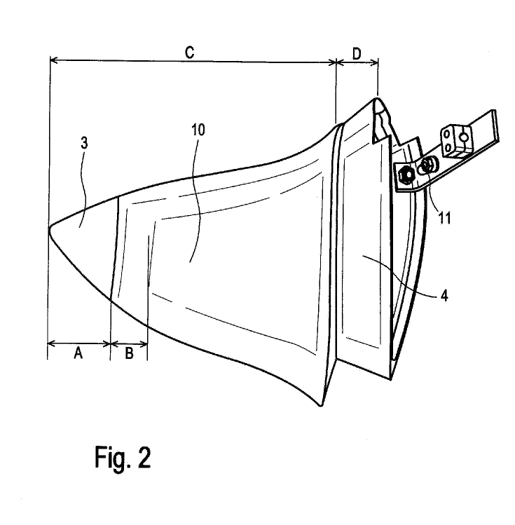

FIG. 2 shows a plan view of the edge arc. In this Figure, only the tip of the lightning receptor 3 can be seen. The inner part of the lightning receptor 6 is incorporated in the edge arc. The ratio (A/B) of the external part 3 to the internal part 6 of the lightning receptor falls between 2.0 and 2.7, whereby a ratio of 2.5 is especially preferred. The ratio (C/D) of the height of the edge arc and the length of the connection to the rotor blade 4 falls between 3 and 3.5.

The lightning protection conductor 5 of the edge arc is connected to the lightning protection system of the rotor blade by means of a screw connection 11.

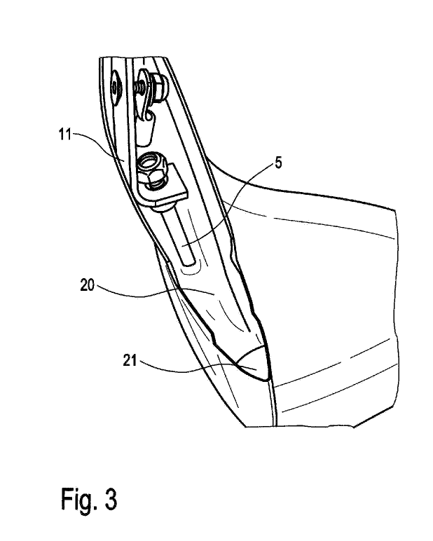

FIG. 3 shows a side plan view of the edge arc 1. The connection to the rotor blade is filled with a water-resistant material 20 so that the connection for the lightning protection 5 does not move during the operation of the wind energy plant, and so that condensation water from the rotor blade cannot penetrate into the edge arc. Accumulated condensation water in the edge arc is discharged through a hole in the edge arc as close as possible to the lightning receptor (not shown here). This hole is ideally drilled at a 45° angle so that no rainwater can penetrate into the edge arc, and the accumulated water can be forced out through the hole. The sides of the of the rotor blade connection 4 are reinforced with a filler, so that the connection is not damaged by the loads that occur.

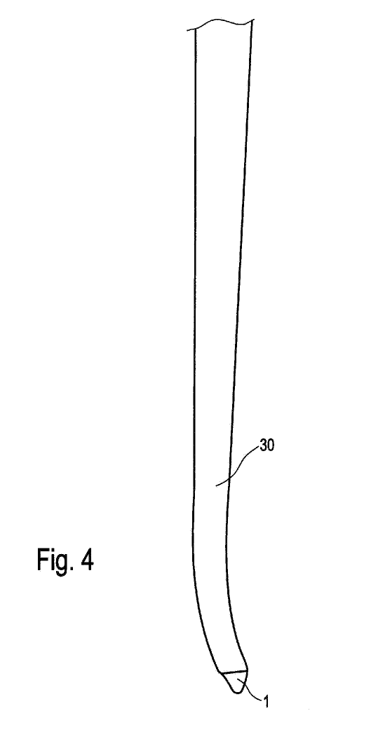

FIG. 4 shows a rotor blade 30 of a wind energy plant having an edge arc 1 according to one embodiment of the invention.

The lightning receptor or lightning protection receptor can also be referred to as the first section of the edge arc. The connection to the rotor blade of the edge arc can also be referred to as the connection region of the edge arc. The lightning receptor or lightning protection receptor respectively has an external and an internal part. The external part forms a tip of the edge arc or has a tip of the edge arc respectively, and the internal part of the lightning receptor or lightning protection receptor respectively is provided for connection to the second part of the edge arc and can also be referred to as a receptor edge.

FIGS. 1 to 3 show in particular the structure of the edge arc, namely in particular the use of different materials in the edge arc, in particular the use of an electrically conductive material for the tip of the lightning receptor 3 and the use of a fiber reinforced plastic essentially for the remaining region of the edge arc.

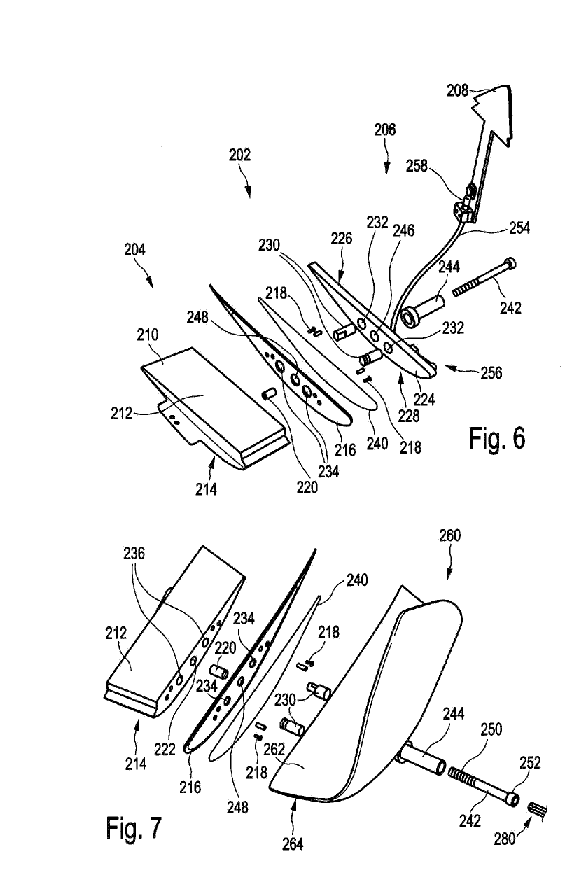

FIGS. 6 to 9 refer to the application of an edge arc or a blade tip respectively to a rotor blade or to the main component of the rotor blade respectively. A connection of this kind can also be used for the edge arc described in FIGS. 1 to 3, whereby small adjustments would be made to the edge arc in FIGS. 1 to 3 if necessary, in particular in order to dispose the tip section on the blade tip or the edge arc according to FIGS. 1 to 3 and to make it possible to actuate the fastener. In any case, the aspects that have been described by way of example in conjunction with FIGS. 1 to 3 can be combined with aspects that have been described by way of example in FIGS. 6 to 9, and such combinations are also proposed according to the embodiments of the present invention.

The rotor blade, which is shown by way of example and very simplified in FIG. 3, may have both an edge arc according to the FIGS. 1 to 3, as well as one according to FIG. 7, and the edge arc 1 is preferably attached by means of a fastening device, as is described, or as parts thereof are described in FIGS. 6 to 9. The overview in FIG. 4 does not depict the concrete way of attaching the edge arc 1 to the rotor blade 30.

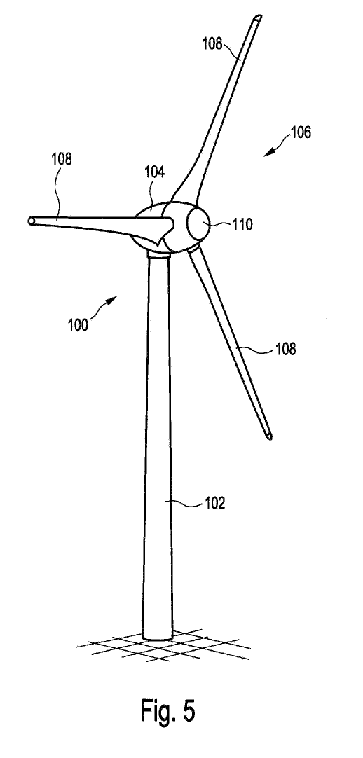

Likewise the rotor blades, which are shown on the wind energy plant according to FIG. 5, may each have an edge arc according to FIGS. 1 to 3 and/or be attached by means of a connection device, regarding which details are explained in FIGS. 6 to 9 by way of example.

FIG. 5 shows a wind energy plant 100 with a tower 102 and a nacelle 104. A rotor 106 with three rotor blades 108 and a spinner 110 is located on the nacelle 104. The rotor 106 is set in operation by the wind in a rotational movement and thereby drives a generator in the nacelle 104. In this sense, FIG. 5 shows a wind energy plant 100 having rotor blades and rotor blade tips or edge arcs according to an embodiment of the invention.

FIG. 6 shows a connection device 202 having a base section 204 and a tip section 206. In addition, a lightning receptor 208 is shown and is connected to the tip section 206 in an electrically conductive manner.

The base section has a blade connection region 210, which must be disposed and attached in a region of the rotor blade, namely at the end thereof. To this end, this base section has, in particular, large adhesive surfaces 212 and 214, which can be bonded there with the glass fiber reinforced material of the rotor blade. A terminal base plate 216 is attached as a closure to the blade connection region 210 by means of two mounting bolts 218. In this case, the terminal base plate 216 has the profile of the rotor blade in this region and thereby achieves a clean closure of the rotor blade all the way to the blade tip being applied.

A thread cylinder 220 is inserted at the terminal base plate 216 from inside, namely in a region facing the blade connection region 210, which thread cylinder has an internal thread and which is accessible from the outside when the base section 204 is in an assembled state.

In the perspective view in FIG. 7, it is also apparent that the blade connection region 210 has a cylinder socket 222 for holding the thread cylinder 220.

FIG. 6 shows, with reference to the tip section 206 that this section has a terminal tip plate 224, which forms a closure for the blade tip to be applied and which likewise has approximately the profile of the rotor blade or of the blade tip in this region. The terminal tip plate 224 is attached to the blade tip in a bonded joint at adhesive surfaces 226 and 228.

In order to apply or insert the blade tip on or in the end of the blade, namely the base section 204, the terminal tip plate 224 has two insertion pins or insertion bolts 230, which are fixedly inserted in the base holes for the base hole pins 232. In order to apply the blade tip to the rotor blade, these insertion pins 230 are then passed through corresponding insertion openings 234 in the terminal base plate 216 and inserted into insertion sockets 236 in the blade connection region 210, which can only be seen in the perspective shown in FIG. 7. A joint 240 is provided between the terminal base plate 216 and the terminal tip plate 224, which has the nature and dimensions of a so-called O-ring seal. The joint 240 allows the terminal base plate 216 and the terminal tip plate 224 to be attached with a small gap at a distance from one another. The joint 240 can hereby provide compensation if necessary.

Locking into place occurs when a bolt 242, which functions as a fastener here, is screwed into the thread cylinder 220 by means of a clamping sleeve 244, a fixing hole 246 and a further center hole 248. Pre-stressing can be maintained by means of the clamping sleeve 244, and fatigue of the connection is thereby avoided or at least significantly delayed.

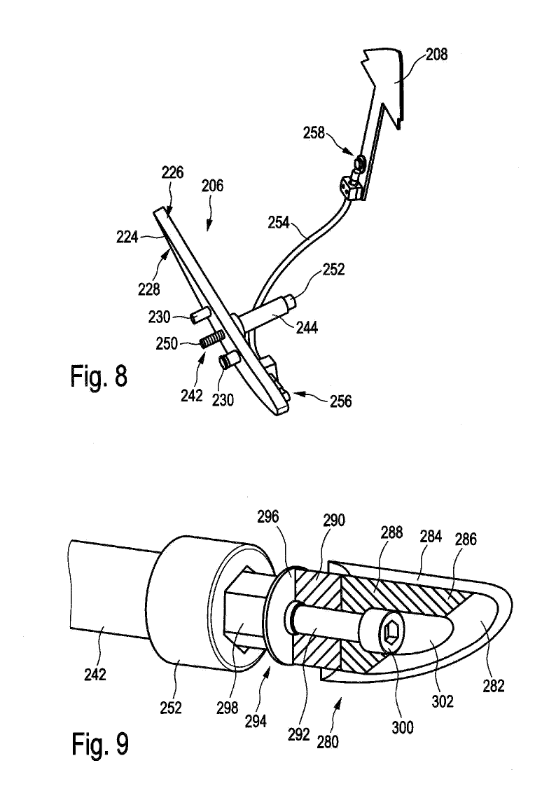

In this respect, FIG. 8 shows an assembled tip section 206, which has been prepared for connection to the base section 204. FIG. 8 also illustrates a first end region 250, by means of which the fastener or the bolt 242 respectively is to engage in the thread cylinder 220, and a second end region 252, which here is designed as a bolt head, and which fits onto the clamping sleeve 244.

In FIGS. 6 and 8, the electrical connection of the lightning receptor 208 is also connected to the terminal tip plate 224 in the region of a plate connection 256 by means of an electrical conductor 254. A receptor connection 258 is provided at the receptor 208.

FIG. 7 also shows a blade tip 260, which is only shown schematically here and, in particular, the lightning receptor 208 is not worked out in this illustration. This blade tip is deflected towards the pressure side 262 of the rotor blade, and therefore to the blade tip 260 as well. A convex curve or, as a result of the curve, a convex surface 266 respectively is thereby created on the suction side 264, through which the fastener 242 can be actuated. In addition, the spacer sleeve 244 and the fastener 242 can also be introduced into the blade tip 260 through such an opening, which is not visible in the perspective shown in FIG. 7. FIG. 7 also shows a sealing element 280. This sealing element 280 is shown in detail in FIG. 9. The partially sectional view in FIG. 9 indicates a surface region 282 of the blade tip 260. In addition, an opening edge 284 is represented in which an opening 286 is formed, into which the sealing element 280 is inserted.

Here, the sealing element 280 has a terminal section 288, which extends to the surface 282 or which forms the surface 282 in the region shown. Adjacent to the terminal section 288 is a compression body 290, whereby the compression body 290 and the terminal section 288 are shown in a sectional view.

In order to provide compression, a compression element 292 is essentially formed as a bolt and engages in a counter body 294. The counter body 294 has a pressure plate 296 and a retaining section 298. The retaining section 298 is designed as an external hexagon and essentially is seated like a corresponding hex key in the bolt head 252 of the fastener 242. The bolt head 252 has an internal hexagonal socket in the region in which the retaining section 298 is placed like a corresponding wrench. The retaining section 298 essentially rests only loosely in this bolt head 252 and the bolt head 252 only prevents the counter body 294 from rotating when the compression element 292 is rotated. Otherwise, there is no connection to the bolt head 252 according to this embodiment. The bolt head 252 thus forms a holding fixture for this retaining section 298.

If the compression element 292 is now screwed into the counter body 294 for example by means of the bolt head 300 thereof, the distance between the terminal section 288 and the pressure plate 296 of the counter body 294 is thereby reduced. The compression body 290 is thereby compressed and widens outward. Thus in the example shown, the sealing element 280 are secured in the opening 286 essentially by means of a frictional connection.

The sealing element 280 also has a small actuation opening 302 so that the compression element 292 can be actuated, which opening is small, however, when compared to the opening 286, and neither poses a problem in terms of aerodynamics, nor easily allows the penetration of water or contaminated air.

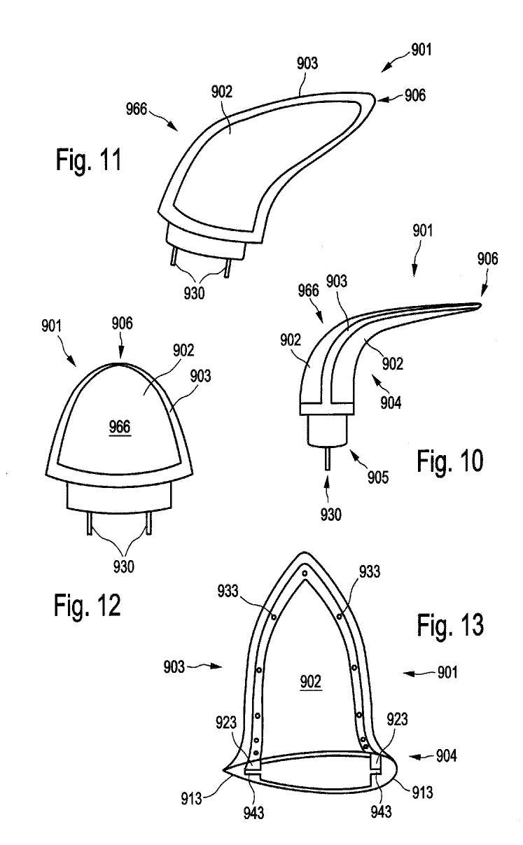

FIG. 10 shows a side view of an edge arc 901 having a tip section 906 and a base section 904. The edge arc 901 has an attachment area 905 with schematically illustrated fastenings 930. The edge arc 901 thereby has a curve that has an outward deflection 966 located between the tip section 906 and attachment area 905. In addition, the edge arc 901 has essentially two sections, namely a first section 903 made of metal and a second section 902 made of an electrically non-conductive material.

FIG. 11 shows a perspective view of the edge arc 901 essentially from the perspective of the outward deflection 966. FIG. 12 shows a view of the edge arc 901 from the perspective of the outward deflection 966. FIGS. 11 and 12 clearly show that the first section 903 encompasses the second section 902.

FIG. 13 shows a sectional view of the edge arc 901 in a section through the base section 904, wherein for the sake of clarity, the sectional areas are not cross hatched. Here, the view shown in FIG. 13 is from the concave side of the edge arc 901, thus from the side facing away from the outward deflection 966.

In this view in FIG. 13, it can be seen that the first section 903 is provided as a frame, and has a holding frame 913 and an attachment frame 923. The attachment frame 923 is attached to the holding frame 913 with fastenings 933. An edge section 943 of the second section 902 is fixedly mounted between the holding frame 913 and the attachment frame 923. Thus in simplistic terms the edge arc 901 can be assembled in such a way that the edge section 943 of the second section 902 can be inserted into the holding frame 913. In so doing, the edge section 943 lies on a corresponding region of the holding frame 913 and is already adapted so that it is custom-fit to the holding frame 913. The attachment frame 923 is then essentially placed on the receiving edge 943 and thereby also inserted into the holding frame 913. By providing the fastenings 933, the edge arc 901 is then connected into a secure unit. This assembly can alternatively or supportively be provided by a bonded joint, for example.

The following embodiments are proposed according to the invention and are to be claimed according to the invention:

### Embodiment 1

An edge arc of a rotor blade of a wind energy plant, wherein the edge arc has a first section made up of at least a first, electrically conductive material, and a second section made up of a second, electrically non-conductive material.

### Embodiment 2

The edge arc according to embodiment 1,

characterized in that

the first material is or comprises a metal, in particular aluminum, and/or that the second material is or comprises a glass fiber reinforced plastic (GFK) or carbon fiber reinforced plastic (CFK).

### Embodiment 3

The edge arc according to embodiment 1 or 2,

characterized in that

in the second section of the edge arc, there is a connection region for connecting to the rotor blade, in particular for insertion into the rotor blade, and in a first section of that edge arc, there is a tip of the edge arc that faces away from the connection region, whereby the tip of the edge arc comprises the first material and the connection region comprises the second material.

### Embodiment 4

The edge arc according to one of the embodiments 1 to 3,

characterized in that

the first section or the first material of the tip of the edge arc respectively extends for a distance of 5% to 30%, in particular 10% to 20% to the connection region, and/or that the second section or the second material respectively extends from the connection region for a distance of 70% to 95%, in particular 80% to 90% to the tip of the edge arc.

### Embodiment 5

The edge arc according to one of the embodiments 1 to 4,

characterized in that

the first section is provided as a lightning receptor and is provided with an electrically conductive connection for lightning conduction, in particular a lightning protection conductor, for connection to an electrical conductor which conducts lightning in the rotor blade, whereby the electrically conductive connection is preferably guided through the second section to the electrical conductor for lightning conduction and/or the electrically conductive connection is provided with a connection means in order to establish an electrical connection to the electrical conductor in the rotor blade.

### Embodiment 6

The edge arc according to one of the embodiments 1 to 5,

characterized in that

the second section has an interior space filled with an insulating material, so that an electrically conductive connection or the electrically conductive connection can be run in an insulated manner.

### Embodiment 7

The edge arc according to one of the embodiments 1 to 6,

characterized in that

an internal space or the internal space is formed out of a shell made out of a honeycomb supportive structure made of plastic, and/or a sealing compound is provided thereon, in particular as an insulating material, and/or that a reinforcement is provided in the second section, which preferably faces a leading edge of the edge arc and/or is disposed adjacent to the honeycomb supportive structure.

### Embodiment 8

The edge arc according to one of the embodiments 1 to 7,

characterized in that

the first section has a receptor edge for connecting to the second section, in particular for insertion into the second section.

### Embodiment 9

The edge arc according to one of the embodiments 1 to 8,

characterized in that

the edge arc is curved, bent or deflected from the first section to the second section, in particular at an angle in the range of 70° to 110°, in particular in the range of 80° to 100°, preferably approximately 90°.

### Embodiment 10

The rotor blade of a wind energy plant comprising an edge arc according to one of the embodiments 1 to 9.

### Embodiment 11

The rotor blade according to embodiment 10, characterized in that the rotor blade has an end region for applying the edge arc and the second section of the edge arc has the same material as the end region of the rotor blade.

### Embodiment 12

Wind energy plant having at least one rotor blade according to embodiment 10 or 11.

### Embodiment 13

Method for producing an edge arc of a rotor blade, in particular according to one of the embodiments 1 to 9, wherein a first section is made of a first, electrically conductive material, and a second section is made of a second, electrically non-conductive material, in particular made of glass fiber reinforced plastic or carbon fiber reinforced plastic, and the first part is at least partially introduced and bonded in a glass fiber fabric or carbon fiber fabric respectively during manufacture, in particular together with a lightning protection conductor.

### Embodiment 14

The method according to embodiment 13,

characterized in that

the second part is produced out of two half shells, of which one is produced for the suction side, and one for the pressure side of the rotor blade.

### KEY

1. edge arc

2. surface edge arc

3. lightning receptor (external part)

4. connection to the rotor blade

5. lightning protection conductor

6. lightning protection receptor (internal part)

10. honeycomb supportive structure for reinforcing the edge arc

11. connection for lightning receptor

20. filling

21. reinforcement

30. rotor blade of a wind energy plant

202. connection device

204. base section

206. tip section

208. lightning receptor

210. blade connection region

212. adhesive surfaces

214. adhesive surfaces

216. terminal base plate

218. mounting bolts

220. thread cylinder

222. cylinder socket

224. terminal tip plate

226. adhesive surfaces

228. adhesive surfaces

230. insertion pins/bolts

232. holes for base hole pins

234. insertion openings

236. insertion sockets

240. joint

242. bolt/fastener

244. clamping sleeve

246. fixing hole

248. center hole

250. first end region

252. second end region/bolt head

254. electrical conductor

256. plate connection

258. receptor connection

260. blade tip

262. pressure side

264. suction side

266. convex surface/curve

280. fastening device

282. surface region

284. opening edge

286. opening

288. terminal section

290. compression body

292. compression means/bolt

294. counter body

296. pressure plate

298. retaining section

300. bolt head 292

302. actuation opening

901. edge arc

902. second section

903. first section

904. base section

905. attachment area

906. tip section

913. holding frame

923. attachment frame

930. fastenings

933. fastenings

943. edge section

966. outward deflection

1. A rotor blade of a wind energy plant comprising:
a main component of the rotor blade;
a connection device having a tip section and a base, wherein the base is attached to the main component; and
a blade tip releasably attached to the main component by the connection device, wherein the tip section of the connection device is attached to the blade tip; and
at least one fastener that extends from the blade tip section to the base section for fastening the tip section to the base section,
wherein the at least one fastener extends through an opening in the surface of the blade tip.

2. The rotor blade according to claim 1, wherein the main section of the blade and the blade tip includes fiber reinforced plastic, and the base section is laminated into the main section of the blade and the tip section is laminated into the blade tip.

3. The rotor blade according to claim 1, wherein at least one of the tip section and the base section has at least one connecting pin for tilt-resistant insertion into corresponding openings in the base section and the tip section, respectively.

4. The rotor blade according to claim 1, wherein the at least one fastener has:
a first end region in a corresponding holding fixture in the base section; and
a second end region disposed in the blade tip and faces away from the first end region, wherein the second end region is located inside of the blade tip, and wherein space remains between the second end region and the surface for a sealing element so that the opening is closed flush with the surface by the seal element.

5. The rotor blade according to claim 1, wherein the at least one fastener is a bolt having a first end region having threads for screwing into a corresponding holding fixture or the corresponding holding fixture in the base section, and having a second end region as a bolt head for actuating the bolt.

6. The rotor blade according to claim 1, wherein the blade tip is deflected towards the pressure side of the rotor blade, and in a resulting outward deflection, the opening is designed to actuate the fastener.

7. The rotor blade according to claim 1, wherein a sealing element is located in the opening in the surface of the blade tip.

8. The rotor blade according to claim 7, wherein a portion of the sealing element enlarges in response to a compressible element for being retained in the opening.

9. The rotor blade according to claim 8, further comprising a bolt to compress the compressible element, wherein the sealing element has a retaining section that is adapted to the at least one fastener, and the fastener has a retaining socket that is adapted to the sealing element, wherein the sealing element is held so that it does not rotate when the bolt is rotated.

10. The rotor blade according to claim 1, wherein the connection device is connected to a lightning receptor or conductor and is prepared to transmit electric current from lightning that strikes the blade tip to the main section of the blade, and the sealing element is insulating, or electrically conductive to transmit the electric current from lightning that strikes the sealing element to the connection device.

11. A connection device for connecting a main component of a rotor blade and a blade tip of the rotor blade to one another, the connection device comprising:
a tip section configured to be attached to the blade tip;
a base section configured to be attached to the main component of the rotor blade; and
at least one fastener that extends from the tip section to the base section for fastening the tip section to the base section, wherein the at least one fastener is configured to extend through an opening in the surface of the blade tip.

12-13. (canceled)

14. A method for mounting a blade tip to a main component of the blade of a rotor blade, the method comprising:
coupling a blade tip to a tip section of a connection device;
coupling a main component of the blade to a base section of the connection device;
placing a fastener through openings in the connection device, the blade tip, and the main component; and
securing of the blade tip by rotating the fastener.

15. The method according to claim 14, wherein after securing, a sealing element is inserted into the opening of the rotor blade and fastened in the opening.

16. An edge arc of a rotor blade of a wind energy plant, the edge arc comprising:
a first section made up of at least a first electrically conductive material, and
a second section made up of a second, electrically non-conductive material.

17. The edge arc according to claim 16, wherein the first section is formed as an edge of the edge arc and entirely or partially encloses the second section.

18. The edge arc according to claim 16, wherein the first section is formed as a frame for receiving or enclosing the second section.

19. The edge arc according to claim 16, the frame includes a holding frame to receive the second section and an attachment frame for attachment to the holding frame and securing the second section to the holding frame.

20. (canceled)

21. A rotor blade of a wind energy plant, comprising:
an edge arc according to claim 16.

22. A wind energy plant comprising:
a rotor blade according to claim 1.

23. (canceled)

24. The rotor blade according to claim 2 wherein the fiber reinforced plastic is glass fiber reinforced plastic.
